(19) United States
(12) Patent Application Publication
(10) Pub. No.: US 2012/0294366 A1
(43) Pub. Date: Nov. 22, 2012

(54) VIDEO PRE-ENCODING ANALYZING METHOD FOR MULTIPLE BIT RATE ENCODING SYSTEM

(76) Inventor: Avi Eliyahu, Tel-Aviv (IL)

(21) Appl. No.: 13/471,965

(22) Filed: May 15, 2012

Related U.S. Application Data
(60) Provisional application No. 61/486,784, filed on May 17, 2011.

(51) Int. Cl. H04N 7/32

(52) U.S. Cl. 375/240.16; 375/E07.123

(57) ABSTRACT

A method for encoding video for communication over a network includes receiving, at a first video encoder, video data that defines frames, generating; by the first video encoder, motion vectors that characterize motion between frames of the video data; and communicating, by the first video encoder, the video data and metadata that defines at least the motion vectors to a second video encoder. The method also includes generating, by the second video encoder, refined motion vectors based on the video data and the motion vectors communicated from the first video encoder; and encoding, by the second video encoder, the video data based on the refined motion vectors.

### RELATED APPLICATIONS

This application claims the benefit of priority to U.S. Provisional Application No. 61/486,784, filed May 17, 2011, the contents of which are hereby incorporated by reference.

### BACKGROUND

1. Field

The subject matter disclosed herein relates generally to video communication systems, and more particularly to a video pre-encoding analyzing method for a multiple bit rate encoding system.

2. Description of Related Art

The Internet has facilitated the communication of all sorts of information to end-users. For example, many Internet user watch videos from content providers such as YouTube®, Netflix®, and Vimeo®, to name a few. The content providers typically stream video content at multiple encoding rates to allow users with differing Internet connection speeds to watch the same source content. For example, the source content may be encoded at a lower bit rate to allow those with slow Internet connections to view to the content. The lower data rate content will tend to be of a poorer video quality. At the other end, high bit rate video is also sent to allow those with faster Internet connections to watch higher resolution video content.

To facilitate streaming of multiple data rates, content providers may utilize various adaptive streaming technologies that provide the same video in multiple bit-rate streams. A decoder at the user end selects the appropriate stream to decode depending on the available bandwidth. These adaptive streaming technologies typically utilize standalone encoders for each video stream. However, this approach requires significant hardware and processing power consumption that scales with the number of streams being encoded.

### BRIEF DESCRIPTION

In a first aspect, a method for encoding video for communication over a network includes receiving, at a first video encoder, video data that defines frames; generating; by the first video encoder, motion vectors that characterize motion between frames of the video data; and communicating, by the first video encoder, the video data and metadata that defines at least the motion vectors to a second video encoder. The method also includes generating, by the second video encoder, refined motion vectors based on the video data and the motion vectors communicated from the first video encoder; and encoding, by the second video encoder, the video data based on the refined motion vectors.

In a second aspect, a video encoding system for communicating video data over a network includes a first video encoder and a second video encoder. The first video encoder is configured to receive video data that defines frames; generate motion vectors that characterize motion between frames of the video data; and communicate the video data and metadata that defines at least the motion vectors to a second video encoder. The second video encoder is configured to generate refined motion vectors based on the video data and the motion vectors communicated from the first video encoder; and to encode the video data based on the refined motion vectors.

In a third aspect, a non-transitory computer readable medium includes code that causes a machine to receive video data that defines frames at a first video encoder; generate motion vectors that characterize motion between frames of the video data; and communicate the video data and metadata that defines at least the motion vectors to a second video encoder. The code also causes the machine to generate refined motion vectors based on the video data and the motion vectors communicated from the first video encoder, and encode the video data based on the refined motion vectors.

### BRIEF DESCRIPTION OF THE DRAWINGS

The accompanying drawings are included to provide a further understanding of the claims, are incorporated in, and constitute a part of this specification. The detailed description and illustrated embodiments described serve to explain the principles defined by the claims.

FIG. 1 illustrates an exemplary video encoding system for communicating video data over a network;

FIG. 2 illustrates an exemplary video pre-encoder that may correspond to a video pre-encoder; and

FIG. 3 illustrates a group of operations performed by the video encoding system.

### DETAILED DESCRIPTION

The embodiments below overcome the problems discussed above by providing an encoding system whereby core-encoding functions common to a number of encoders is performed in a video pre-encoder rather than redundantly in all the encoders. The video pre-encoder communicates processed video data and metadata that includes motion information associated with the video data to back-end encoders. The back-end encoders are so-called lean encoders that are not required to perform full motion search of the video data. Rather, the back-end encoders perform a refined motion search operation based on the motion information. The refined motion search operation is less computationally intensive than a full motion search.

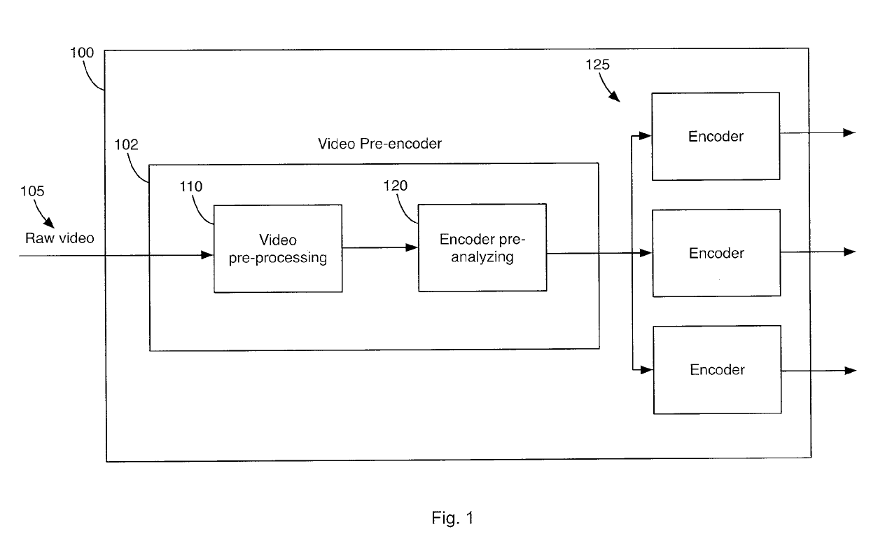

FIG. 1 illustrates an exemplary video encoding system 100 for communicating video data over a network. The video encoding system 100 includes a video pre-encoder 102 and one or more back-end video encoders 125. The video encoding system 100 may be implemented via one or more processors that execute instruction code optimized for performing video compression. For example, the video encoding system 100 may include one or more general-purpose processors such as Intel® x86, ARM®, and/or MIPS® based processors, or specialized processors, such as a graphical processing unit (GPU) optimized to perform complex video processing operations. In this regard, the video pre-encoder 102 and one or more back-end video encoders 125 may be considered as separate encoder stages of the video encoding system 100. Alternatively, the video pre-encoder 102 and one or more back-end video encoders 125 may be implemented with different hardware components. That is, the various encoders referred to throughout the specification are understood to be either separate encoder systems, different encoder stages of a single system, or a combination thereof.

The video pre-encoder 102 may include a video pre-processing block 110 and an encoder pre-analyzing block 120. The video pre-processing block 110 is configured to process raw video 105 by performing operations, such as scaling, cropping, noise reduction, de-interlacing, and filtering on the raw video 105. Other pre-processing operations may be performed.

The encoder pre-analyzing block 120 is configured to perform motion search operations. In this regard, the encoder pre-analyzing block 120 is configured to generate metadata, which includes motion vectors that define motion between frames of the processed video. The metadata also includes a frame type (e.g., I, B, P) associated with the motion vectors, and a cost for any partition (e.g., 16×16, 8×8, 16×8, 8×16), as described in more detail below. The metadata is linked to specific video frames. The encoder pre-analyzing block 120 communicates the processed video and the metadata to the back-end video encoders 125.

The back-end video encoders 125 are configured to encode the processed video data into a compressed video stream, such as an H.264, Vp8, etc., based on the metadata, and to communicate the encoded video data over a network, such as the Internet. In this regard, the back-end video encoders 125 may include hardware and execute instruction code for encoding the video data. However, because the metadata already includes the motion search information, the back-end video encoders 125 do not have to perform this function, which can be 50% to 70% of the total encoding process when performing H.264 encoding. Though, in some implementations, the back-end video encoders 125 are configured to refine the motion search information. This may be necessary because typical encoders preform motion search using encoded frames while the encoder pre-analyzing block 120 performs the motion search on processed raw video, which isn't encoded. This can result in a slight offset between the processed video motion search and encoded video motion search, could result in a loss of video quality. The motion vectors in the metadata may, therefore, be used as pivots for a light motion search algorithm in the encoders to determine the final motion vectors. However, the refinement is significantly less computationally intensive than the motion search performed by the video pre-encoder 102. Of course, it is understood that back-end encoders may encode the video data without further refinement if the loss of quality is acceptable.

Offloading the majority of the motion search process to the video pre-encoder 102 relaxes the hardware requirements of the back-end video encoders 125. The relaxed hardware requirements facilitate the implementation of multiple back-end encoders 125 on the same piece of hardware. This allows, for example, a single CPU to execute multiple instances of video-encoder code for streaming encoded video at different bit rates over a network. For example, a first back-end video encoder 125 may generate a video stream with high definition video information while a different back-end video encoder 125 generates a video stream with standard definition information.

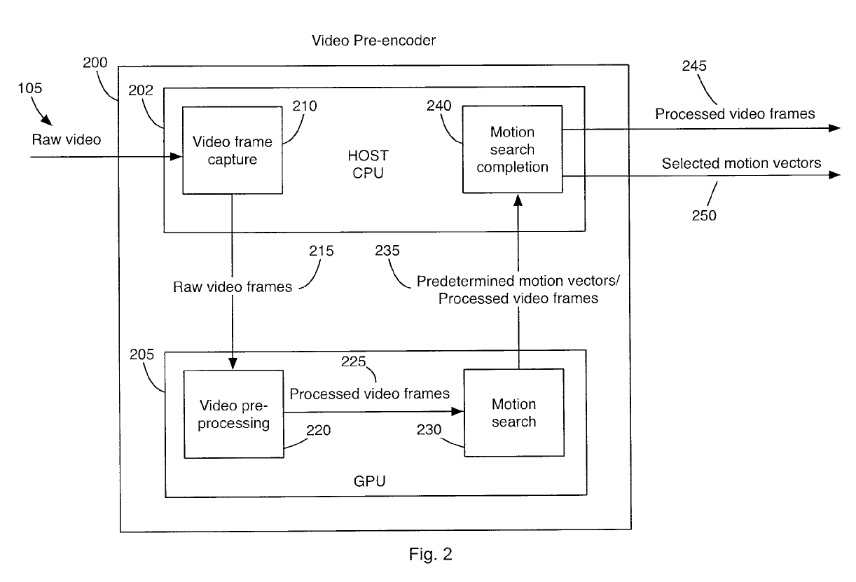

FIG. 2 illustrates an exemplary video pre-encoder 200 that may correspond to the video pre-encoder 102 illustrated in FIG. 1. Referring to FIG. 2, the video pre-encoder 200 includes a host CPU 202 and a graphical processing unit (GPU) 205. While the CPU 202 and GPU 205 are illustrated as separate entities, it is understood that the principals described herein apply equally as well to a single CPU system, or a single GPU system and that the disclosed embodiments are merely exemplary implementations.

The host CPU 202 may include or operate in conjunction with a video frame capture block 210 and a motion search completion block 210. The video frame capture block 210 is configured to capture frames of raw video 105. For example, the video frame capture block 210 may include analog-to-digital converters for converting NTSC, PAL, or other analog video signals to a digital format. In this regard, the video frame capture block 210 may capture the raw video 105 as RGB, YUV, or using a different color space. In alternative implementations, the video frame capture block 210 may be configured to retrieve previously captured video frames stored on a storage device, such as a hard drive, CDROM, solid state memory, etc. In this case, the frames may be represented as digital RGB, YUV, etc. The video frame capture block 210 is configured to communicate raw video frames 215 to the GPU for further processing.

The GPU 205 may include or operate in conjunction with a video pre-processing block 220 and a motion search block 230. Though, as noted above, the video pre-processing block 220 and the motion search block 230 may be included with or operate in conjunction with the host CPU 202. The video pre-processing block 220 is configured to receive raw video frames 215 from the video frame capture block 210 and to perform pre-processing operations on the raw video frames 215. For example, the video pre-processing block 220 may perform operations such as noise reduction, de-interlacing, resizing, cropping, filtering, and frame dropping, on the raw video frames 215. The noise reduction operations remove noise on the input video to improve the quality of the processed video frames 225. De-interlacing operations may be utilized to convert interlaced video signals to progressive signals, which are more suitable for certain devices. Resizing and cropping may be performed to meet video resolution requirements specified by a user. 2-dimensional and 3-dimensional filters may be utilized to improve the quality of low-resolution video. Frame dropping operations may be performed to change the frame rate between the source of the video and destination for the video. For example, 3:2 pull-down operations may be performed. The processed video frames 225 are then communicated to the motion search block 230.

The motion search block 230 is configured to receive the processed video frames 225 from the video pre-processing block 220 and to perform a motion search on the processed video frames 225. For example, the motion search block 230 may split the processed video frames 225 into macro-blocks and then perform motion search between respective macro-blocks in the current frame and reference frames, which may correspond to previous frames or future frames. The motion search results in a group of motion vectors that are associated with different frames, which may be I-frames, P-frames, or B-frames. In this regard, the motion search block 230 determines the order/type of frames (i.e., the GOP sequence). The frame type may be determined by knowledge of the GOP structure or may be determined dynamically. For example, the frame type may be determined via a scene change in the processed video frames 225. When the motion search block 230 determines that the current frame is a B frame, frame buffering of processed video frames 225 is enabled, which in turn initiates the motion search. The motion search block 230 maintains the pre-analyzed GOP sequence.

The operations described above may be performed on full resolution video frames. In alternative implementations, the motion search block 230 may perform a reduced resolution search or partial search instead. For example, motion search may be performed at a quarter of the resolution of the processed video frames 225. In this case, the motion search results may be obtained more quickly or with a lesser processor. Though accuracy may be impacted to some degree. However, the refinement operations of the back-end encoders 125 could be extended to make up for the difference in accuracy.

After determining the motion vectors, the motion search block 230 communicates the motion vectors and the frame type (i.e., I, P, or B) with which the motion vectors are associated to the motion search completion block 240.

The motion search completion block 210 is configured to receive the motion vectors and processed video frames 235 from the motion search block 230. The motion search completion block 240 selects the top N highest rated motion vectors from the pre-determined motion vectors and communicates the motion vectors along with the processed video frames to the back-end encoders 125. The top N number of motion vectors corresponds to those motion vectors that have the highest similarity between macro-blocks in the current frame and the previous reference frame or between the current frame and the next reference frame. The similarity may be determined based on a cost parameter such as the sum-of-absolute-differences (SAD) between pixels of the macro-blocks of the current frame and reference frames.

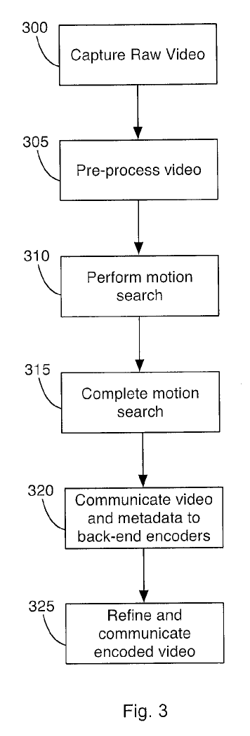

FIG. 3 illustrates a group of operations performed by the video encoding system 100. As noted above, some or all of these operations may be performed by the processors and other blocks described above. In this regard, the video encoding system 100 may include one or more non-transitory forms of media that store computer instructions for causing the processors to perform some or all of these operations.

Referring to FIG. 3, at block 300, raw video is captured. For example, the video frame capture block 210 may capture frames of raw video 105. In this regard, the video frame capture block 210 may utilize analog-to-digital converters to convert NTSC, PAL, or other analog video signal to a digital format.

At block 305, the digitized video signal (i.e., raw video frames 215) are pre-processed. For example, the video pre-processing block 220 may perform operations such as noise reduction, de-interlacing, resizing, cropping, filtering, and frame dropping, on the raw video frames 215.

At block 310, motion search may be performed on the processed video frames 225. For example, the motion search block 230 may split the processed video frames 225 into macro-blocks. A motion search algorithm may be applied between respective macro-blocks in the current frame and reference frames resulting in a group of motion vectors that are associated with different frames, which may be I-frames, P-frames, or B-frames.

At block 315, the motion search may be completed. For example, the motion search completion block 240 may select the top N highest rated motion vectors from the motion vectors communicated from the motion search block 230.

At block 320, the selected motion vectors are communicated to the back-end encoders 125 along with the processed video frames 245. The motion vectors may be communicated in the form of metadata that is associated with each frame of the processed video frames 245. In this regard, in addition to the selected motion vectors, the frame type and cost described above may be communicated in the metadata.

At block 325, the back-end video encoders 125 encode the processed video frames 245 based on the information in the metadata. In this regard, the back-end video encoders 125 may perform a small motion search around the selected motion vectors and may perform a cost calculation based on encoder-reconstructed frames (i.e., already encoded frames).

As shown, the video encoding system 100 is capable of providing multiple streams of encoded video data with a minimum of processing power by performing core encoding functions common to all the back-end encoders in a video pre-encoder rather than in all the back-end encoders. This advantageously facilitates lowering the cost associated with such a system by allowing the use of less powerful processors. In addition, power consumption is potentially lowered, because more power efficient processors may be utilized to perform the various operations.

While various embodiments of the embodiments have been described, it will be apparent to those of ordinary skill in the art that many more embodiments and implementations are possible that are within the scope of the claims. Accordingly, it will be apparent to those of ordinary skill in the art that many more embodiments and implementations are possible that are within the scope of the claims. Therefore, the embodiments described are only provided to aid in understanding the claims and do not limit the scope of the claims.

What is claimed is:

1. A method for encoding video for communication over a network comprising:
receiving, at a first video encoder, video data that defines frames;
generating, by the first video encoder, motion vectors that characterize motion between frames of the video data;
communicating, by the first video encoder, the video data and metadata that defines at least the motion vectors to a second video encoder;
generating, by the second video encoder, refined motion vectors based on the video data and the motion vectors communicated from the first video encoder;
encoding, by the second video encoder, the video data based on the refined motion vectors.

2. The method according to claim 1, wherein the received video data is non-temporally compressed.

3. The method according to claim 1, further comprising performing at least one operation from the group of operations consisting of: noise reduction, de-interlacing, resizing, cropping, filter, and frame dropping, on the video data prior to generation of the motion vectors by the first video encoder.

4. The method according to claim 1, wherein the metadata further defines a frame type associated with the motion vectors.

5. The method according to claim 4, wherein the motion vectors defined by the metadata correspond to a number of motion vectors that produce a highest similarity between macro-blocks in a current frame and a previous or next reference frame of the video data.

6. The method according to claim 5, wherein the metadata further defines a cost for the macro-blocks.

7. The method according to claim 1, further comprising:
communicating, by the first video encoder, the video data and metadata that defines at least the motion vectors to a plurality of video encoders;
generating, by the plurality of video encoders, refined motion vectors based on the video data and the motion vectors communicated from the first video encoder;
encoding, by the plurality of video encoders, the video data at a based on the refined motion vectors, wherein each of the plurality of video encoders encodes the video data at a different rate.

8. A video encoding system for communication of video data over a network, the video encoding system comprising:
a first video encoder configured to:
receive video data that defines frames;
generate motion vectors that characterize motion between frames of the video data;
communicate the video data and metadata that defines at least the motion vectors to a second video encoder;
a second video encoder configured to:
generate refined motion vectors based on the video data and the motion vectors communicated from the first video encoder; and
encode the video data based on the refined motion vectors.

9. The video encoding system according to claim 8, wherein the received video data is non-temporally compressed.

10. The video encoding system according to claim 8, wherein the first video encoder is further configured to perform at least one operation from the group of operations consisting of: noise reduction, de-interlacing, resizing, cropping, filter, and frame dropping, on the video data prior to generation of the motion vectors by the first video encoder.

11. The video encoding system according to claim 8, wherein the metadata further defines a frame type associated with the motion vectors.

12. The video encoding system according to claim 11, wherein the motion vectors defined by the metadata correspond to a number of motion vectors that produce a highest similarity between macro-blocks in a current frame and a previous or next reference frame of the video data.

13. The video encoding system according to claim 12, wherein the metadata further defines a cost for the macro-blocks.

14. The video encoding system according to claim 8, wherein the first video encoder is further configured to:
communicate the video data and metadata that defines at least the motion vectors to a plurality of video encoders, and
wherein the plurality of video encoders are further configured to:
generate refined motion vectors based on the video data and the motion vectors communicated from the first video encoder;
encode the video data at a based on the refined motion vectors, wherein each of the plurality of video encoders encodes the video data at a different rate.

15. A non-transitory computer readable medium having stored thereon at least one code section for encoding video for communication over a network, the at least one code section being executable by a machine to cause the machine to perform acts of:
receiving video data that defines frames at a first video encoder;
generating motion vectors that characterize motion between frames of the video data;
communicating the video data and metadata that defines at least the motion vectors to a second video encoder;
generating refined motion vectors based on the video data and the motion vectors communicated from the first video encoder;
encoding the video data based on the refined motion vectors.

16. The non-transitory computer readable medium according to claim 15, wherein the received video data is non-temporally compressed.

17. The non-transitory computer readable medium according to claim 15, wherein the at least one code section is further executable to cause the machine to perform acts of: performing at least one operation from the group of operations consisting of: noise reduction, de-interlacing, resizing, cropping, filter, and frame dropping, on the video data prior to generation of the motion vectors by the first video encoder.

18. The non-transitory computer readable medium according to claim 15, wherein the metadata further defines a frame type associated with the motion vectors.

19. The non-transitory computer readable medium according to claim 18, wherein the motion vectors defined by the metadata correspond to a number of motion vectors that produce a highest similarity between macro-blocks in a current frame and a previous or next reference frame of the video data.

20. The non-transitory computer readable medium according to claim 19, wherein the metadata further defines a cost for the macro-blocks.
